(19) United States
(12) Patent Application Publication
(10) Pub. No.: US 2012/0163037 A1
(43) Pub. Date: Jun. 28, 2012

(54) RESONANT CONVERTER

(75) Inventors: Sungsoo HONG, Goyang-si (KR); Chungwook RHO, Seoul (KR); Sangkyoo HAN, Daejeon-si (KR); Jonghae KIM, Suwon-si (KR); Jaesun WON, Suwon-si (KR); Taewon LEE, Suwon-si (KR); Jinwook KIM, Seoul (KR)

(73) Assignee: Samsung Electro-Mechanics Co., Ltd., Suwon-si (KR)

(21) Appl. No.: 13/281,651

(22) Filed: Oct. 26, 2011

(30) Foreign Application Priority Data
Dec. 24, 2010 (KR) 10-2010-0134696

(51) Int. Cl. H02M 3/335

(52) U.S. Cl. 363/21.02

(57) ABSTRACT

Disclosed herein is a resonant converter, including: a power conversion circuit alternately switching applied DC power to output a predetermined level of output power; and a control circuit fixing an operating frequency and controlling the level of the output power by varying the comparison voltage level that is a comparison target of the operating frequency, by determining that a short circuit occurs when the output current of the power conversion circuit is a reference current or more by comparing the output current of the power conversion circuit with the reference current. By this configuration, the output current can be constantly controlled even when the short circuit occurs in the output of the resonant converter.

### CROSS REFERENCE(S) TO RELATED APPLICATIONS

This application claims the benefit under 35 U.S.C. Section 119 of Korean Patent Application Serial No. 10-2010-0134696, entitled “Resonant Converter” filed on Dec. 24, 2010, which is hereby incorporated by reference in its entirety into this application.

### BACKGROUND OF THE INVENTION

1. Technical Field

The present invention relates to a resonant converter, and more particularly, to a resonant converter used for a power supply such as a switching mode power supply (SMPS), etc.

2. Description of the Related Art

Generally, a power supply such as a switching mode power supply (SMPS), or the like, is needed in order to drive electronic devices such as an air conditioner, an audio, a personal computer, etc.

The switching mode power supply implies a device that uses a switch device such as a metal-oxide-semiconductor field effect transistor (MOSFET) to convert DC voltage into sine-wave voltage and then, outputs a desired level of DC voltage using a resonant converter.

Meanwhile, with the increased specifications of the electronic device, a demand for various protection functions has been increased. Among those, the protection circuit for the resonant converter is to prevent the damage to circuits by interrupting power applied to the resonant converter if it is determined that a short circuit occurs by sensing whether the short circuit occurs in an output stage.

However, the protection circuit for the resonant converter interrupts power applied thereto when the short circuit occurs in the output stage to stop the driving of the resonant circuit, such that it is difficult to satisfy various demands of a user that wants to drive the electronic devices even at the time of a short circuit.

Therefore, there is a need to constantly control the output current even when the short circuit occurs in the output stage of the resonant converter.

### SUMMARY OF THE INVENTION

An object of the present invention is to provide a resonant converter capable of constantly controlling output current even when a short circuit occurs in an output stage of a resonant converter.

According to an exemplary embodiment of the present invention, there is provided a resonant converter, including: power conversion circuit alternately switching applied DC power to output a predetermined level of output power; and a control circuit fixing an operating frequency and controlling the level of the output power by varying the comparison voltage level that is a comparison target of the operating frequency, by determining that a short circuit occurs when the output current of the power conversion circuit is a reference current or more by comparing the output current of the power conversion circuit with the reference current.

The control circuit may include: a first frequency controller controlling the operating frequency according to a first error voltage that is a comparison result between the voltage level of the output power and the preset first reference voltage level to control the operating frequency; and a second frequency controller controlling the operating frequency according to a second error voltage that is a comparison result between a voltage level of a output current sensing resistor RL of the power conversion circuit and a preset second reference voltage level.

The control circuit may include a voltage controller outputting the comparison voltage that is a comparison result between the voltage level of the output current sensing resistor RL of the power conversion circuit and a preset third reference voltage level.

The control circuit may perform the constant current control of the output power in a pulse width modulation manner varying the comparison voltage output from the voltage controller when the short circuit Occurs.

The control circuit may be operated in a pulse frequency modulation scheme that varies the operating frequency to control the level of the output power when the output current of the power conversion circuit is less than the reference current.

The control circuit may include: a frequency setting unit setting the operating frequency according to the first or second error voltages; a triangular wave generator generating a triangular wave according to the operating frequency; a duty controller comparing a triangular wave generated from the triangular wave generator with the comparison voltage output from the voltage controller to control the switching duty of the power conversion circuit; and a switching controller outputting the first and second switching signals controlling the alternate switching of the power conversion circuit according to the switching duty control of the duty controller.

The first frequency controller may include a first error amplifier comparing the voltage level of the output power with the first reference voltage level to amplify the first error voltage that is the comparison result, and the second frequency controller may include a second error amplifier amplifying the second error voltage that is a comparison result obtained by comparing the voltage level of the output current sensing resistor((RL)) of the power conversion circuit with the second reference voltage level.

The voltage controller may include a third error amplifier that amplifies the comparison voltage that is the comparison result obtained by comparing the voltage level of the output current sensing resistor((RL)) of the power conversion circuit with the third reference voltage level.

The control circuit may include a selection controller performing a control to operate only one of the first and second frequency controllers.

The selection controller may perform a control to operate the frequency controller outputting a low voltage level among the first and second voltage levels output from the first and second frequency controllers.

The first frequency controller may output the bias voltage, the power voltage as the first error voltage when the short circuit occurs, and the second frequency controller may output zero voltage as the second error voltage when the short circuit occurs.

The frequency setting unit may set the operating frequency to a maximum operating frequency according to the zero voltage, when the zero voltage is output from the second frequency controller due to the occurrence of a short circuit.

The voltage controller may reduce the third error voltage, the comparison voltage to perform the constant current control of the output power when the short circuit occurs.

The second reference voltage level may be a maximum value or more of the voltage applied to the output current sensing resistor RL of the power conversion circuit and may be set to be lower than the short circuit voltage applied to the output current sensing resistor RL that is the maximum voltage when the short circuit occurs.

The third reference voltage level may be set to the short circuit voltage applied to the output current sensing resistor RL that is the maximum voltage when the short circuit occurs.

The second reference voltage level may be set to be lower than the third reference voltage level.

### BRIEF DESCRIPTION OF THE DRAWINGS

FIG. 1 is a configuration diagram of a resonant converter according to an exemplary embodiment of the present invention;

FIG. 2 is a detailed configuration diagram of a control circuit shown in FIG. 1; and

FIG. 3 is an operation waveform diagram of a resonant converter according to an exemplary embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application. Hereinafter, exemplary embodiments of the present invention will be described in detail with reference to the accompanying drawings.

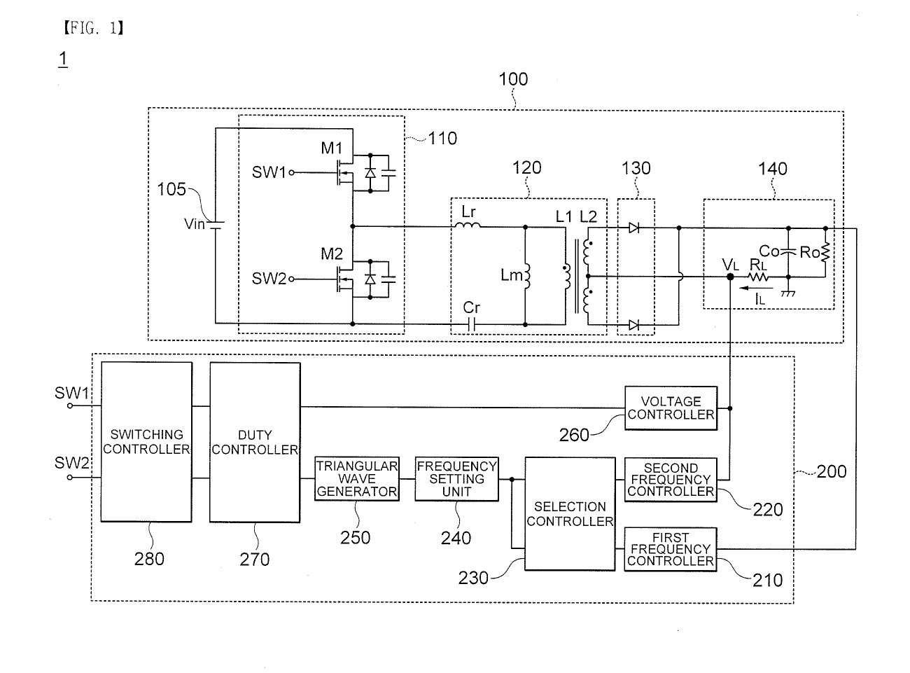

FIG. 1 is a configuration diagram of a resonant converter according to an exemplary embodiment of the present invention.

As shown in FIG. 1, a resonant converter 1 is configured to include a power conversion circuit 100 and a control circuit 200.

First, an exemplary embodiment of the present invention will describe, by way of example, an inductor-inductor-capacitor (LLC) resonant converter among resonant converters.

The power conversion circuit 100 is a device that alternately switches applied DC power Vin (alternately switching on/off) to a predetermined level of output power Vo. The power conversion circuit 100 is configured to include a switching unit 110, a converter 120, a rectifier 130, and a smoothing output unit 140.

The switching unit 110 include first and second switches M1 and M2 that are connected between two electrodes, a positive (+) electrode and a negative (−) electrode of a power input stage 105 in series and connected to the power input stage 105 in parallel.

The first and second switches M1 and M2 receives first and second switching signals SW1 and SW2 having different phases from the control circuit 200 to alternately perform the switching on/off operation. That is, the first switch M1 is turned-on, the second switch M2 performs the switching-off operation so that the switching-on operation period of the first and second switches M1 and M2 do not overlap.

The AC power switched in the switching unit 110 is transferred to the converter 120.

The converter 120 is configured of a single transformer and may be configured of a resonant Capacitor Cr, and a resonant inductor Lr, and an LLC resonant converter including a magnetizing inductor Lm connected to the second switch M2 in parallel.

The AC power switched in the switching unit 110 is converted into AC power having a predetermined level of voltage according to a preset turn ratio of the converter 120 and is transferred to the rectifier 130.

The rectifier 130 is a unit that rectifies the AC power converted in the converter 120. A rectifying element of the rectifier 130 is configured of at least one diode to half-wave rectify the AC power and is configured of a bridge diode including a plurality of diodes to full-wave rectify the AC power.

The smoothing output unit 140 is a unit that smoothes the AC power rectified in the rectifier 130 to output DC power, that is, output power Vo and is configured of an output capacitor Co to transfer the output DC power to the control circuit 200. Further, the smoothing output unit 140 further includes an output resistor Ro connected to the output capacitor Co in parallel.

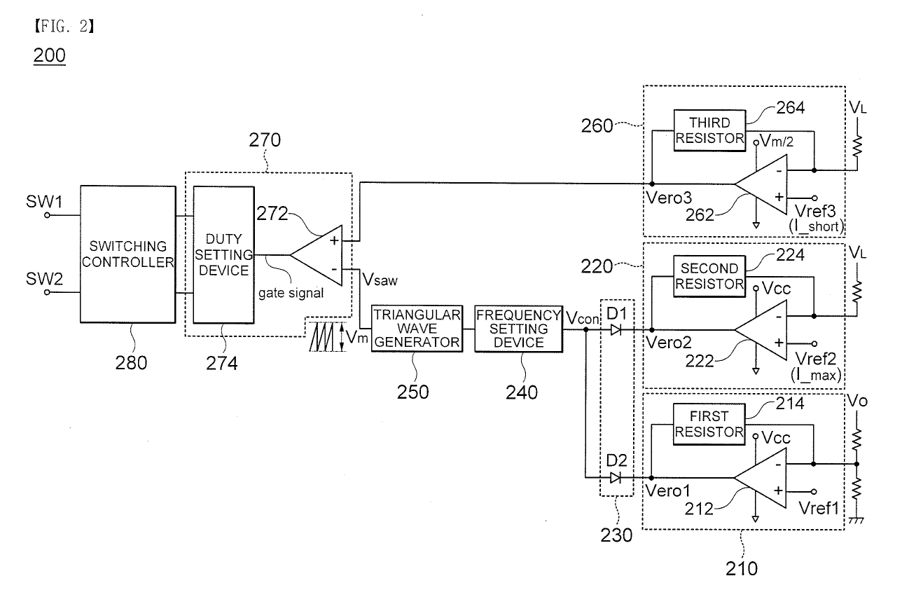

FIG. 2 is a detailed configuration diagram of a control circuit shown in FIG. 1. As shown in FIGS. 1 and 2, the control circuit 200 is configured to include first and second frequency controllers 210 and 220, a selection controller 230, a frequency setting unit 240, a triangular wave generator 250, a voltage controller 260, a duty controller 270, and a switching controller 280.

The first frequency controller 210 controls the operating frequency according to a first error voltage Vero1 that is a comparison result between a voltage level of the output power Vo and a preset first reference voltage level Vref1.

The first frequency controller 210 is configured to include a first error amplifier 212 amplifying an error between the voltage level of the output power Vo and the preset first reference voltage level Vref1 and a first resistor 214 setting an error amplification rate of the first error amplifier 212 according to the preset resistance value.

The operation process the first frequency controller 210 will be described at the time of the normal operation where the short circuit does not occur in the output stage of the power conversion circuit 100 and the occurrence of a short circuit, based on the above-mentioned contents.

When the magnitude in load is increased, the power stored in the output capacitor Co is lowered and the level of the output power Vo is lowered accordingly. Therefore, the first error amplifier 212 compares the first reference voltage level Vref1 with the level of the low output power Vo to output the first error voltage Vero1 higher than a reference error voltage Vt.

On the other hand, when the magnitude in load is reduced, the power stored in the output capacitor Co is increased and the level of the output power Vo is increased accordingly. Therefore, the first error amplifier 212 compares the first reference voltage level Vref1 with the increased level of the output power Vo to output the first error voltage Vero1 lower than a reference error voltage Vt.

However, when the short circuit occurs in the output stage of the power conversion circuit 100, the output power Vo becomes zero voltage 0V and the first error amplifier 212 outputs the comparison voltage between the first reference voltage level Vref1 and the zero voltage such that the first error voltage Vero1 is continuously increased and output. Therefore, the first error voltage Verro1 is saturated to a bias voltage of the first error amplifier 212, that is, a power voltage Vcc such that the first error amplifier 212 outputs the power voltage Vcc.

The second frequency controller 220 controls the operating frequency according to a second error voltage Vero2 that is a comparison result between the voltage level (that is, a voltage level of an output current IL) applied to an output current sensing resistor RL of the power conversion circuit 100 and the preset second reference voltage level Vref2.

The second frequency controller 220 is configured to include a second error amplifier 222 amplifying an error between the voltage level VL applied to the output current sensing resistor RL and the preset second reference voltage level Vref2 and a second resistor 224 setting an error amplification rate of the second error amplifier 222 according to the preset resistance value.

In this configuration, the output current sensing resistor RL is a resistive element connected between the rectifier 130 and the output capacitor Co. When the short circuit occurs in the output stage of the power conversion circuit 100, the output voltage Vo becomes the zero voltage 0V and the voltage level of the output current sensing resistor RL is increased with the increase of the output current IL.

Further, the voltage level applied to the output current sensing resistor RL is converted into voltage and detected, after sensing the output current IL.

Describing the operation of the second frequency controller 220 based on the above-mentioned description, since the voltage level VL applied to the output current sensing resistor RL at the time of the normal operation becomes very small voltage (the output current sensing resistor RL has a resistor having a very small resistance value) approaching “0”, the second error amplifier 222 is operated like the non-inverting circuit to saturate the second error voltage Vero2 to the bias voltage, that is, the power voltage Vcc, such that the second error amplifier 222 outputs the power voltage Vcc at all times.

If the short circuit occurs, the second reference voltage level Vref2 is lower than the voltage level applied to the output current sensing resistor RL, such that the second error voltage Vero2 becomes a negative (−) voltage and the second error amplifier 222 cannot output the negative (−) voltage as the second error voltage Vero2, such that another bias voltage, that is, the zero voltage 0V is output from the second error amplifier 222.

As described above, the frequency setting unit 240 sets the operating frequency to the preset maximum operating frequency according to the output of the zero voltage 0V from the second error amplifier 222 and the triangular wave generator 250 outputs a triangular wave in synchronization with the maximum operating frequency.

Meanwhile, describing the second and third reference voltage levels Vref2 and Vref3 of the second and third error amplifiers 222 and 262, the second reference voltage level Vref2 is set to be the maximum value or more of the voltage applied to the output current sensing resistor RL of the power conversion circuit 100 and is set to be smaller than the maximum voltage at the time of the occurrence of the short circuit, the short circuit voltage applied to the output current sensing resistor RL. In addition, a third reference voltage level Vref3 of the third error amplifier 262 is set to the maximum voltage at the time of the occurrence of the short circuit, that is, the short circuit voltage applied to the output current sensing resistor RL.

In other words, this is set to the second reference voltage level (a maximum value of the voltage applied to the output current sensing resistor RL)<a third reference voltage level (a short circuit voltage applied to the output current sensing resistor RL).

Referring again to FIG. 2, the selection controller 230 is configured to include first and second selection diodes D1 and D2 to perform a control to operate only one of the first and second frequency controllers 210 and 220.

That is, the selection controller 230 performs a control to operate the frequency controller outputting the low voltage level among the first and second error voltage Vero1 and Vero2 output from the first and second frequency controllers 210 and 220.

Describing in more detail, the second error voltage Vero2 at the time of the normal operation, which is the bias voltage, i.e., the power voltage Vcc, is larger than the first error voltage Vero1, such that the selection controller 230 operates the first frequency controller 210 to control the output power Vo.

However, when the short circuit occurs, the second reference voltage level Vref2 is lower than the voltage level at the time of the short circuit to set the second error voltage Vero2 to be lower than the first error voltage Vero1, such that the selection controller 230 operates the second frequency controller 220.

The frequency setting unit 240 sets the operating frequency according to the first or second error voltage Vero1 and Vero2 output from the first or second frequency controller 210 and 220. The operating frequency signal set in the frequency setting unit 240 is transferred to the triangular wave generator 250.

That is, the magnitude of the load is increased at the time of the normal operation, the voltage stored in the output capacitor Co is lowered, such that the first error amplifier 212 outputs the first error voltage Vero1 higher than the reference error voltage Vt and thus, the frequency setting unit 240 sets the operating frequency to be low.

On the other hand, the magnitude of the load is increased, the voltage stored in the output capacitor Co is increased, such that the first error amplifier 212 outputs the first error voltage Vero1 lower than the reference error voltage Vt and thus, the frequency setting unit 240 sets the operating frequency to be high.

The triangular wave generator 250 generates a triangular wave synchronized with the operating frequency signal set in the frequency setting unit 240. The triangular wave is transferred to the duty controller 270.

The voltage controller 260 outputs the third error voltage Vero3 that is a comparison result between the voltage level applied to the output current sensing resistor RL of the power conversion circuit 100 and the preset third reference voltage level Vref3.

The voltage controller 260 is configured to include a third error amplifier 262 amplifying an error between the voltage level VL applied to the output current sensing resistor RL and the preset third reference voltage level Vref3 and a third resistor 264 setting the error amplification rate of the third error amplifier 262 according to the preset resistance value.

Describing in more detail, the comparison voltage that is the third error voltage Vero3 output from the third error amplifier 262 at the time of the normal operation is saturated to a second bias voltage Vm/2 that is a half of the peak voltage of the triangular wave while being saturated to the bias voltage, such that the following comparator 272 outputs a gate signal having a duty of 0.5.

If the output current IL is continuously increased due to the occurrence of the short circuit, the voltage level of the output current IL reaches the third reference voltage level Vref3 and thus, the third error voltage Vero3 of the third error amplifier 262 is not saturated to the second bias voltage Vm/2 and gradually increased.

As described above, the second frequency controller 220 fixes the operating frequency to the maximum operating frequency and the voltage controller 260 varies the third error voltage Vero3, the comparison voltage to vary the duty of the gate signal, thereby making it possible to control the output power in a constant current.

The duty controller 270 is configured to include a comparator 272 comparing the third error voltage that is a comparison result of the third error amplifier 262 with the voltage level of the triangular wave output from the triangular wave generator 250 and a duty setting device 274 setting the switching duty according to the gate signal that is a comparison result of the comparator 272. The duty signal output from the duty setting device 274 is transferred to the switching controller 274.

The switching controller 280 transfers the first and second switching signals SW1 and SW2 that control the switching of first and second switches M1 and M2 to the switching unit 110 according to the duty signal from the duty setting device 274.

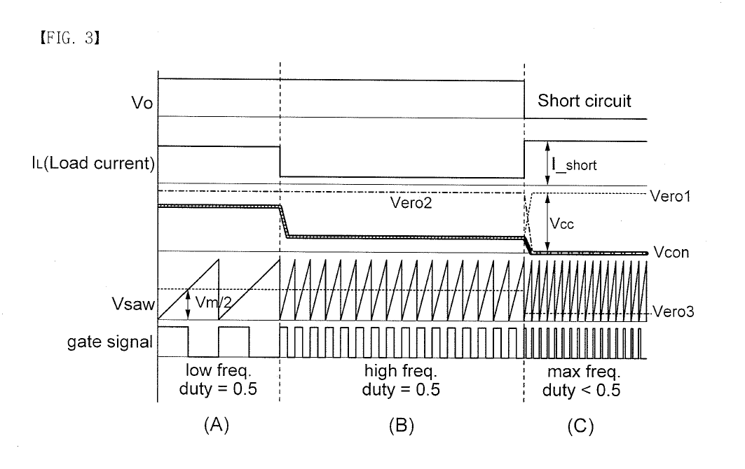

FIG. 3 shows an operation waveform diagram of the resonant converter according to the exemplary embodiment of the present invention.

Referring to FIGS. 1 to 3, the operation process of the resonant converter according to the exemplary embodiment of the present invention will be described in detail.

First, the first and second switches M1 and M2 are alternately switched according to the switching of the control circuit 200 to operate at the duty of D and 1-D.

The charging voltage of the resonant capacitor Cr is controlled by being alternately switched-on/off in the first and second switches M1 and M2 to control the voltage applied to a primary winding L1 of the converter 120, such that the DC power, that is, the output power Vo is formed through a secondary winding L2 of the transformer 120, the rectifier 130, and the smoothing output unit 140.

In this case, the output power Vo is precisely controlled through the control circuit 200.

In the control circuit 200, describing in more the process of controlling the output power Vo, the second reference voltage Vref2 of the second error amplifier 222 is the maximum value or more of the voltage applied to the output current sensing resistor RL of the power conversion circuit 100 and is set to be lower than the short voltage applied to the maximum voltage at the time of the occurrence of the short circuit, that is, the output current sensing resistor RL. In addition, a third reference voltage level Vref3 of the third error amplifier 262 is set to the maximum voltage at the time of the occurrence of the short circuit, that is, the short circuit voltage applied to the output current sensing resistor RL.

In other words, this is set to the second reference voltage level (a maximum value of the voltage applied to the output current sensing resistor RL)<a third reference voltage level (a short circuit voltage applied to the output current sensing resistor RL).

As described above, after the reference voltage level is set, the second error voltage Vero2 output from the second error amplifier 222 at the time of the normal operation where the output of the power conversion circuit 100 is not a short circuited is saturated to the bias voltage, the power voltage Vcc.

During the normal operation, since the voltage level applied to the output current sensing resistor RL becomes a very small voltage (detecting the voltage corresponding to the output current by using the output current sensing resistor RL having a very small resistance value) approaching ‘0’, the second error amplifier 222 is operated like the non-inverting circuit (operated as a differential amplifier), such that the second error voltage Vero2 is increased to the power voltage Vcc and thus, the second error voltage Vero2 does not increase the power voltage Vcc or more. That is, the second error voltage Vero2 is saturated to the bias voltage of the second error amplifier 222, the power voltage Vcc.

Therefore, the second error voltage (Vero2=Vcc) is larger than the first error voltage Vero1, such that the selection controller 230 operates the first frequency controller 210 to control the output power Vo.

Meanwhile, the third error voltage Vero3 output from the third error amplifier 262 is saturated to the second bias voltage Vm/2 that is a half of the peak voltage Vm of the triangular wave while being saturated to the bias voltage, such that the gate signal outputs the duty of 0.5.

As shown in FIGS. 3A and 3B, when the load is increased, the voltage stored in the output capacitor Co is lowered, such that the first error voltage Vero1 output from the first error amplifier 212 is higher than the reference error voltage Vt and thus, the frequency setting unit 240 sets the operating frequency to be low.

On the other hand, when the load is reduced, the voltage stored in the output capacitor Co is increased, such that the first error amplifier 212 output from the first error amplifier 212 is lower than the reference error voltage Vt and thus, the frequency setting unit 240 sets the operating frequency to be high to constantly maintain the output power Vo.

In summary, when the load is increased in the normal operation mode, the first error voltage Vero1 of the first error amplifier 212 is increased to be the voltage level Vm and the triangular wave having a low frequency is generated to be applied to the negative (−) terminal of the comparator 272 and the positive (+) terminal of the comparator 272 is applied with the third error voltage, the second bias voltage Vm/2 such that the input and output voltage ratio is increased by outputting the gate signal having the duty of 0.5 and the slow operating frequency from the comparator 272.

On the other hand, the first error voltage Vero1 of the first error amplifier 212 is reduced to be the voltage level Vm and the triangular wave having a high frequency is generated to be applied to the negative (−) terminal of the comparator 272 and the positive (+) terminal of the comparator 272 is applied with the third error voltage, the second bias voltage Vm/2 such that the input and output voltage ratio is reduced by outputting the gate signal having the duty of 0.5 and the fast operating frequency from the comparator 272.

As shown in FIG. 3C, when the short circuit occurs in the output end of the power conversion circuit 100, the output voltage Vo becomes the zero voltage 0V, such that the first error voltage Vero1 of the first error amplifier 212 is continuously increased to be saturated to the bias voltage, that is, the power voltage Vcc.

When the zero voltage is applied to the first error amplifier 212, the first error amplifier 212 is operated like the non-inverting circuit such that the first error voltage Vero1 is increased to the bias voltage, the power voltage Vcc due to the amplification ratio of the first error amplifier 212 and when the first error voltage Vero1 is increased to the power voltage, such that the first error voltage Vero1 is no further increased. In other words, the first error voltage Vero1 is saturated to the bias voltage, the power voltage Vcc.

As the comparison result of the second error amplifier 222, the second reference voltage level Vref2 is lower than the voltage level applied to the output current sensing resistor RL at the time of the short circuit, such that the second error amplifier 222 output the voltage lower than the voltage level at the time of the normal operation. Therefore, the second error voltage Vero2 is lower than the first error voltage Vero1, such that the selection controller 230 is operated like the second frequency controller 220.

In addition, as the comparison result of the second error amplifier 222, since the second reference voltage level Vref2 is lower than the voltage level applied to the output current sensing resistor RL at the time of the short circuit to output a negative (−) voltage level, the second error voltage Vero2 is saturated to another bias voltage, “0” and Vcon is fixed to 0 by the first and second selection diodes D1 and D2 of the selection controller 230, such that the operating frequency is increased to the maximum operating frequency to be fixed to the maximum operating frequency.

As described above, when the zero voltage is applied to the triangular wave generator 250, the reason why the operating frequency is increased to the maximum operating frequency is that the IC controller of the LLC resonant converter sets the minimum operating frequency and the maximum operating frequency in order to secure the stabilized zero voltage switching (ZVS) operation according to the used load conditions and the triangular wave generator 250 is not increased to the set maximum frequency or more according to the application of the zero voltage to the triangular wave generator 250 while when the voltage applied to the triangular wave generator 250 is increased, the operation frequency is reduced so as not to reduce the operating frequency any more when the operating frequency becomes the set minimum frequency or less.

Next, when the output current is continuously increased to reach the third reference voltage level Vref3, the third error amplifier 262 is not saturated to the second bias voltage Vm/2 and enters the control area as shown in FIGS. 3B and 3C, and the third error voltage Vero3 is gradually reduced to vary its duty.

Describing in more detail, the third error amplifier 262 at the time of the normal operation saturates the third error voltage Vero3 to the second bias voltage Vm/2 due to the amplification ratio of the third error amplifier 262 since the voltage applied to the output current sensing resistor RL is approximately “0”. When the output current is increased to be increased to the short circuit current, the voltage level applied to the output current sensing resistor RL is increased to reduce the third error voltage Vero3, such that the constant current control is performed due to the operation of the pulse width modulation (PWM) manner by the fixed maximum operating frequency and the reduced third error voltage Vero3.

That is, when the operating frequency is fixed to the maximum operation frequency at the time of the occurrence of the short circuit and the third error voltage Vero 3 is varied to vary its duty, such that the output power can be subjected to the constant current control.

As set forth above, the resonant converter according to the exemplary embodiment of the present invention can constantly control the output current even when the short circuit occurs in the output end of the resonant converter.

Further, the exemplary embodiment of the present invention can control the output current in the pulse frequency modulation (PFM) scheme controlling the level of output power according to the operating frequency when the resonant converter is normally operated and constantly control the output current in the pulse width modulation (PWM) scheme when the short circuit occurs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A resonant converter, comprising:
a power conversion circuit alternately switching applied DC power to output a predetermined level of output power; and
a control circuit fixing an operating frequency and controlling the level of the output power by varying the comparison voltage level that is a comparison target of the operating frequency, by determining that short-circuit occurs when the output current of the power conversion circuit is a reference current or more by comparing the output current of the power conversion circuit with the reference current.

2. The resonant converter according to claim 1, wherein the control circuit includes:
a first frequency controller controlling the operating frequency according to a first error voltage that is a comparison result between the voltage level of the output power and the preset first reference voltage level to control the operating frequency;
a second frequency controller controlling the operating frequency according to a second error voltage that is a comparison result between a voltage level of an output current sensing resistor of the power conversion circuit and a preset second reference voltage level.

3. The resonant converter according to claim 2, wherein the control circuit includes a voltage controller outputting the comparison voltage that is a comparison result between the voltage level of the output current sensing resistor of the power conversion circuit and preset third reference voltage level.

4. The resonant converter according to claim 3, wherein the control circuit performs the constant current control of the output power in a pulse width modulation manner varying the comparison voltage output from the voltage controller when the short circuit occurs.

5. The resonant converter according to claim 1, wherein the control circuit is operated in a pulse frequency modulation scheme that varies the operating frequency to control the level of the output power when the output current of the power conversion circuit is less than the reference current.

6. The resonant converter according to claim 3, wherein the control circuit includes:
a frequency setting unit setting the operating frequency according to the first or second error voltages;
a triangular wave generator generating a triangular wave according to the operating frequency;
a duty controller comparing a triangular wave generated from the triangular wave generator with the comparison voltage output from the voltage controller to control the switching duty of the power conversion circuit; and
a switching controller outputting the first and second switching signals controlling the alternate switching of the power conversion circuit according to the switching duty control of the duty controller.

7. The resonant converter according to claim 2, wherein the first frequency controller includes a first error amplifier comparing the voltage level of the output power with the first reference voltage level to amplify the first error voltage that is the comparison result, and
the second frequency controller includes a second error amplifier amplifying the second error voltage that is a comparison result obtained by comparing the voltage level of the output current sensing resistor of the power conversion circuit with the second reference voltage level.

8. The resonant converter according to claim 3, wherein the voltage controller includes a third amplifier that amplifies the comparison voltage that is the comparison result obtained by comparing the voltage level of the output current sensing resistor of the power conversion circuit with the third reference voltage level.

9. The resonant converter according to claim 2, wherein the control circuit includes a selection controller performing a control to operate only one of the first and second frequency controllers.

10. The resonant converter according to claim 9, wherein the selection controller performs a control to operate the frequency controller outputting a low voltage level among the first and second voltage levels output from the first and second frequency controllers.

11. The resonant converter according to claim 6, wherein the first frequency controller outputs the bias voltage, the power voltage as the first error voltage when the short circuit occurs, and
the second frequency controller outputs zero voltage as the second error voltage when the short circuit occurs.

12. The resonant converter according to claim 11, wherein the frequency setting unit sets the operating frequency to a maximum operating frequency according to the zero voltage, when the zero voltage is output from the second frequency controller due to the occurrence of a short circuit.

13. The resonant converter according to claim 11, wherein the voltage controller reduces the third error voltage, the comparison voltage to perform the constant current control of the output power when the short-circuit occurs.

14. The resonant converter according to claim 3, wherein the second reference voltage level is a maximum value or more of the voltage applied to the output current sensing resistor of the power conversion circuit and is set to be lower than the short circuit voltage applied to the output current sensing resistor that is the maximum voltage when the short circuit occurs.

15. The resonant converter according to claim 3, wherein the third reference voltage level is set to the short circuit voltage applied to the output current sensing resistor that is the maximum voltage when the short circuit occurs.

16. The resonant converter according to claim 3, wherein the second reference voltage level is set to be lower than the third reference voltage level.
